(19) United States
(12) Patent Application Publication
(10) Pub. No.: US 2011/0248921 A1
(43) Pub. Date: Oct. 13, 2011

(54) KEYCAP CONSTRUCTION FOR KEYBOARD WITH DISPLAY FUNCTIONALITY

(75) Inventor: Glen C. Larsen, Issaquah, WA (US)

(73) Assignee: MICROSOFT CORPORATION, Redmond, WA (US)

(21) Appl. No.: 12/757,734

(22) Filed: Apr. 9, 2010

(51) Int. Cl. G06F 3/02

(52) U.S. Cl. 345/168

(57) ABSTRACT

A computer peripheral is provided. The computer peripheral includes a display device and a keyboard assembly disposed over the display device. The keyboard assembly is configured to permit viewing of images produced by the display device through the keyboard assembly. The keyboard assembly includes a plurality of keys. Each of the plurality of keys is selectively physically depressible to cause production of an input signal. Each of the plurality of keys includes a keycap having a perimeter piece and a central piece. The central piece is transparent so as to permit passage of light from the display device through the central piece to a user of the keyboard assembly.

### BACKGROUND

Computer peripherals are continually being refined to expand functionality and provide quality user experiences. One area of improvement has been to provide peripheral devices that combine keyboard-type input functionality with the ability to display output to the user. In many cases, this is implemented by providing a keyboard with a display region that is separate from the keys. For example, in a conventional keyboard layout, a rectangular LCD display can be situated above the function keys or number pad.

Another approach to combining input and output capability in a peripheral device is the use of a virtual keyboard on a touch interactive display. In this case, the display capability is provided directly on the keys: each key typically is displayed by the touch interactive device with a legend or symbol that indicates its function. The virtual keyboard approach has many benefits, including the ability to dynamically change the display for each key. Interactive touch displays are often less desirable, however, from a pure input standpoint. Specifically, touch displays do not provide tactile feedback, which can provide a more responsive and agreeable typing experience.

### SUMMARY

According to one aspect of the disclosure, a computer peripheral is provided. The computer peripheral includes a display device and a keyboard assembly including a plurality of keys. The keyboard assembly is disposed over the display device. The keyboard assembly is configured to permit viewing of images produced by the display device through the keyboard assembly. Each of the keys of the keyboard assembly is selectively physically depressible to cause production of an input signal. Further, each of the keys of the keyboard assembly includes a keycap having a perimeter piece and a central piece. The central piece is transparent so as to permit passage of light from the display device through the central piece to a user of the keyboard assembly.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary computing system including a computer peripheral that provides the ability to display viewable output in connection with the keys of a keyboard assembly.

FIG. 2 is an exploded view of the computer peripheral shown in FIG. 1, and shows viewable display output being provided by a display device underlying the keyboard assembly of the computer peripheral.

FIG. 3 illustrates an example of the output display capability that may be employed in connection with the computer peripheral of FIGS. 1 and 2.

FIGS. 4 and 5 are partial-section views of an embodiment of a key that may be employed in connection with the computer peripheral of FIGS. 1 and 2.

FIGS. 6 and 7 are bottom and top perspective views of an embodiment of a two-piece keycap, including a central transparent piece to facilitate through-key viewing of images produced by a display device underlying the keyboard assembly.

FIG. 8 illustrates an exemplary configuration for a keyboard assembly base structure having offset tactile feedback structures.

FIG. 9 is a side view of a key which illustrates viewing considerations associated with through-key viewing of images.

FIGS. 10 and 11 are exploded views showing further exemplary key constructions.

### DETAILED DESCRIPTION

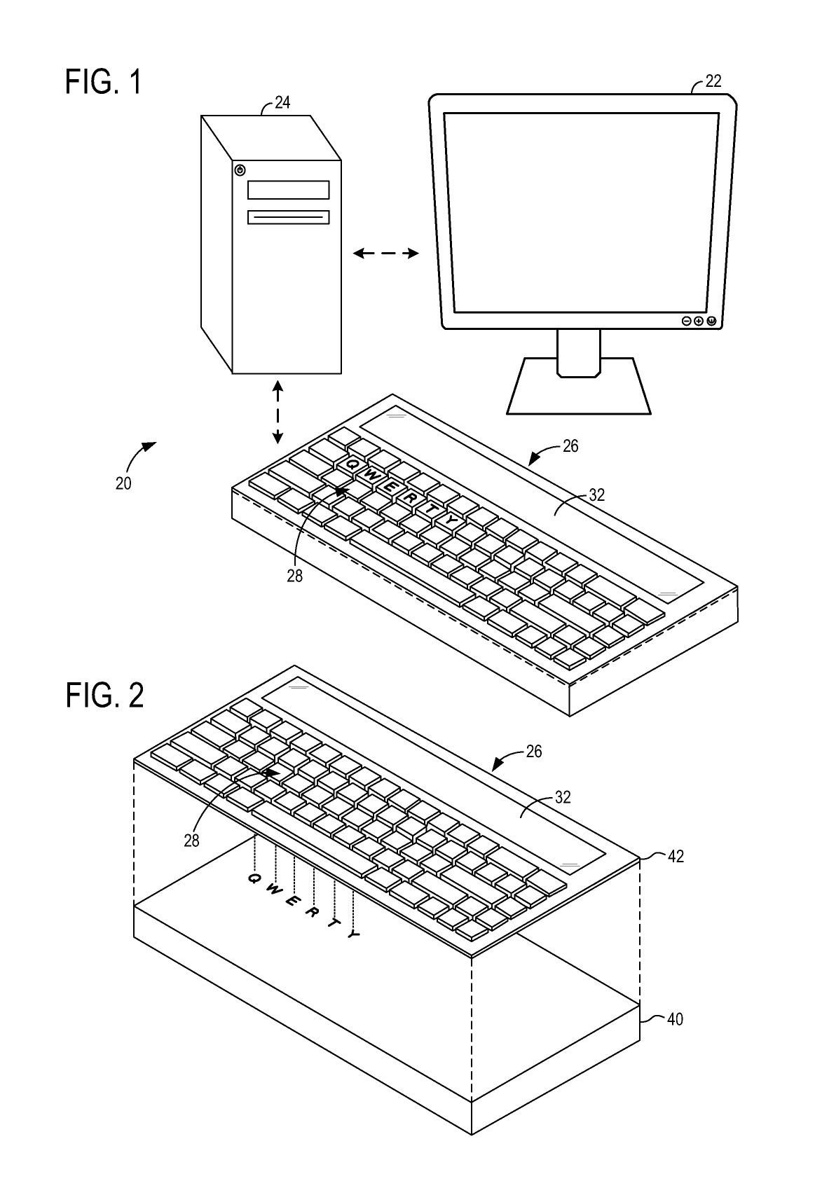

FIG. 1 depicts an exemplary computing system 20 including a display monitor 22, a component enclosure 24 (e.g., containing a processor, hard drive, etc.), and a computer peripheral 26. FIG. 2 provides an additional view of computer peripheral 26 and exemplary components that may be used in its construction. As will be described in various examples, computer peripheral 26 may be implemented to provide displayable output in addition to keyboard-type input functionality. Among other things, the computer peripheral may include keys employing a two-piece construction with transparent components to facilitate through-key viewing of images. The two-piece construction may also be employed to optionally conceal or reduce the visual impact of portions of the peripheral device that are not related to the display functionality.

The terms “input” and “output” will be used frequently in this description in reference to the keyboard functionality of the exemplary computer peripherals. When used in connection with a keyboard key, the term “input” will generally refer to the input signal that is provided by the peripheral upon activation of the key. “Output” will generally refer to the display provided for a key, such as the displayed legend, icon or symbol that indicates the function of the key.

As indicated by the “Q”, “W”, “E”, “R”, “T”, “Y”, etc. on keys 28 (FIGS. 1 and 2), it will often be desirable that computer peripheral 26 be configured to provide conventional alphanumeric input capability. To simplify the illustration, many keys of FIGS. 1 and 2 are shown without indicia, though it will be appreciated that a label or display will often be included for each key. Furthermore, in addition to or instead of the well-known “QWERTY” formulation, the keys 28 of the keyboard may be variously configured to provide other inputs. Keys may be assigned, for example, to provide functionality for various languages and alphabets, and/or to activate other input commands for controlling computing system 20. In some implementations, the key functions may change dynamically, for example in response to the changing operational context of a piece of software running on computing system 20. For example, upon pressing of an “ALT” key, the key that otherwise is used to enter the letter “F” might instead result in activation of a “File” menu in a software application. Generally, it should be understood that the keys in the present examples may be selectively depressed to produce any type of input signal for controlling a computer.

Computer peripheral 26 can provide a wide variety of displayable output to enhance and otherwise augment the computing experience. In some examples, the computer peripheral causes a display of viewable output on or near the individual keys 28 to indicate key function. This can be seen in FIGS. 1 and 2, where instead of keys with letters painted or printed onto the keycap surface, a display mechanism (e.g., a liquid crystal display (LCD) device situated under the keys) is used to indicate the “Q”, “W”, etc. functions of the keys. This dynamic and programmable display capability facilitates potential use of the computer peripheral 26 in a variety of different ways. For example, the English-based keyboard described above could be alternately mapped to provide letters in alphabetical order instead of the conventional “QWERTY” formulation, and the display for each key could then be easily changed to reflect the different key assignments.

The display capability contemplated herein may be used to provide any type of viewable output to the user of computing system 20, and is not limited to alphabets, letters, numbers, symbols, etc. As an alternative to the above examples, images may be displayed in a manner that is not necessarily associated in a spatial sense with an individual key. An image might be presented, for example, in a region of the keyboard that spans multiple keys. The imagery provided need not be associated with the input functionality of the keyboard. Images might be provided, for example, for aesthetic purposes, to personalize the user experience, or to provide other types of output. Indeed, the present disclosure encompasses display output for any purpose. Also, in addition to display provided on or near keys 28, display functionality may be provided in other areas, for example in an area 32 located above keys 28. Still further, area 32 or other portions of computer peripheral 26 may be provided with touch or gesture-based interactivity in addition to the keyboard-type input provided by keys 28. For example, area 32 may be implemented as an interactive touchscreen display, via capacitance-based technology, resistive-based technology or other suitable methods.

Turning now to FIG. 2, computer peripheral 26 may include a display device 40 and a keyboard assembly 42 disposed over and coupled with the display device. Keyboard assembly 42 may be at least partially transparent, to allow a user to view images produced by the display device through the keyboard assembly. In one embodiment, for example, each key 28 has a central transparent portion that allows a user to see the images produced by an LCD panel or other display device situated underneath keyboard assembly 42. In some cases, substantially all of the key will be transparent. In other examples, a periphery portion of the key may be opaque, for example to conceal structures that facilitate upward and downward movement of the keycap.

A variety of types of display device 40 may be employed. As indicated briefly above, one type of suitable display device is an LCD device. Indeed, LCD devices will be frequently referred to in the examples discussed herein, though this is non-limiting and it should be appreciated that the keyboard assembly may be coupled with a variety of other display types.

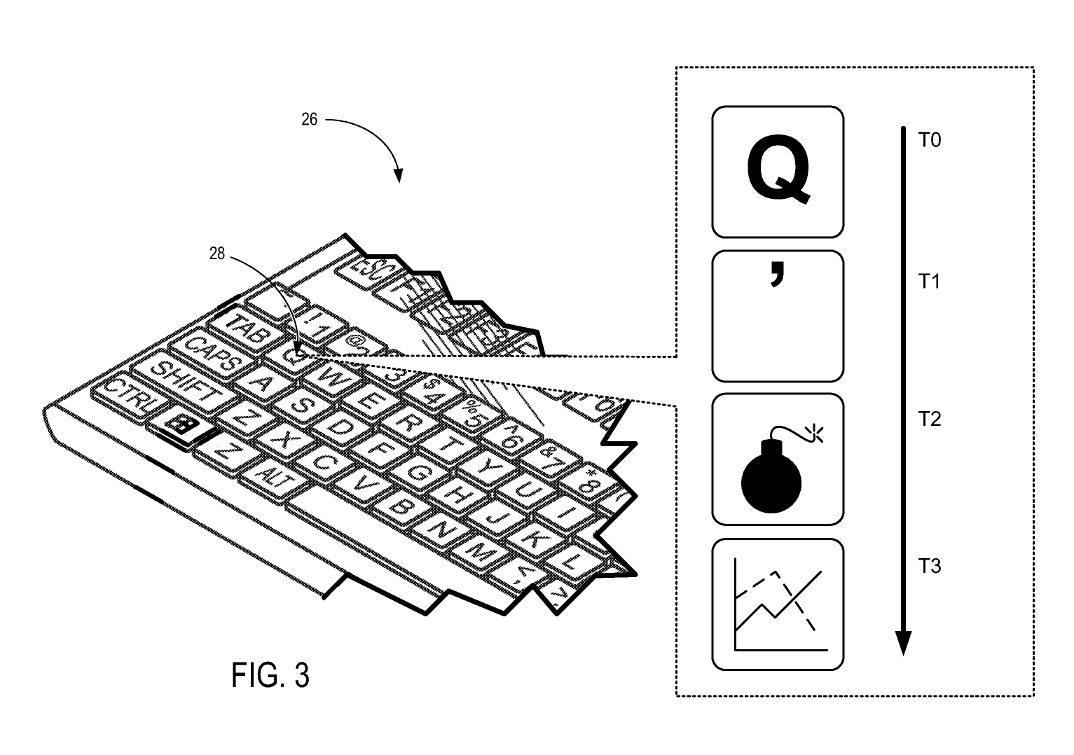

FIG. 3 provides further illustration of how the display capability of computer peripheral 26 may be employed in connection with an individual key 28. In particular, as shown respectively at times T₀, T₁, T₂, etc., the display output associated with key 28 may be changed, for example to reflect the input command produced by depressing the key. However, as previously mentioned, the viewable output provided by the computer peripheral may take forms other than displays associated with individual keys and their input functionality.

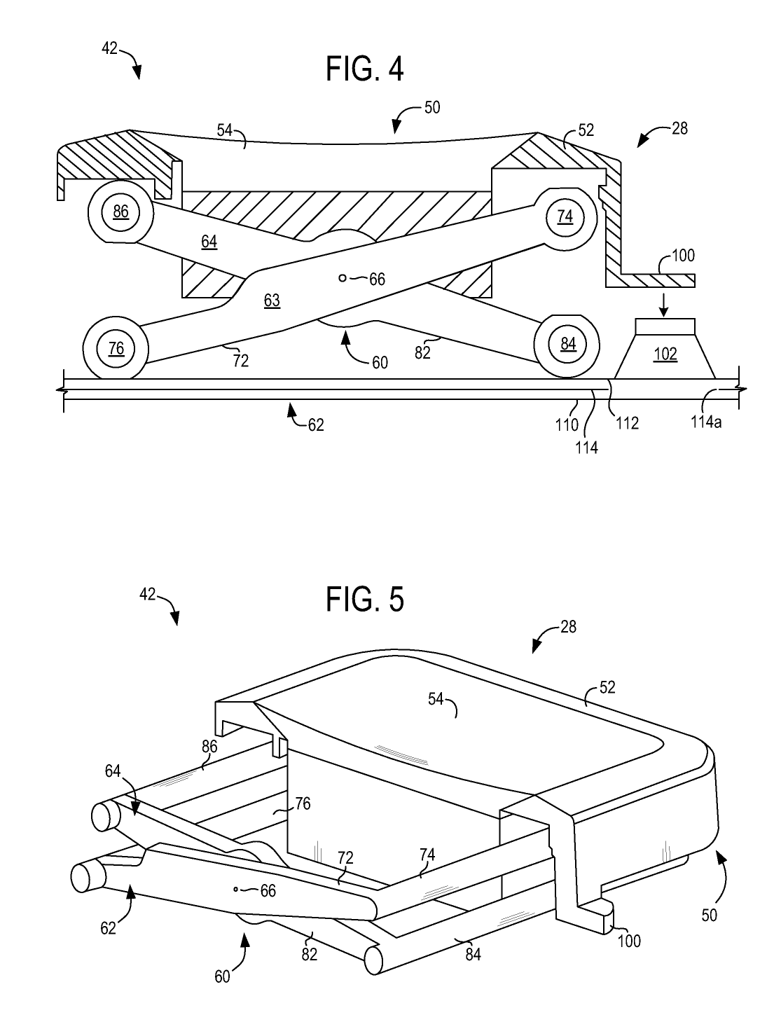

As in the examples of FIGS. 1 and 2, keyboard assembly 42 typically will include a plurality of keys employing some type of mechanism that enables the keys to be depressed or otherwise moved to produce an input signal. Although the term “keys” will be used primarily, this term is non-limiting, and should be understood to include buttons and any other structure or mechanism that may be moved by a user to provide input. FIGS. 4 through 11 show example structures that may be employed to implement individual keys of keyboard assembly 42.

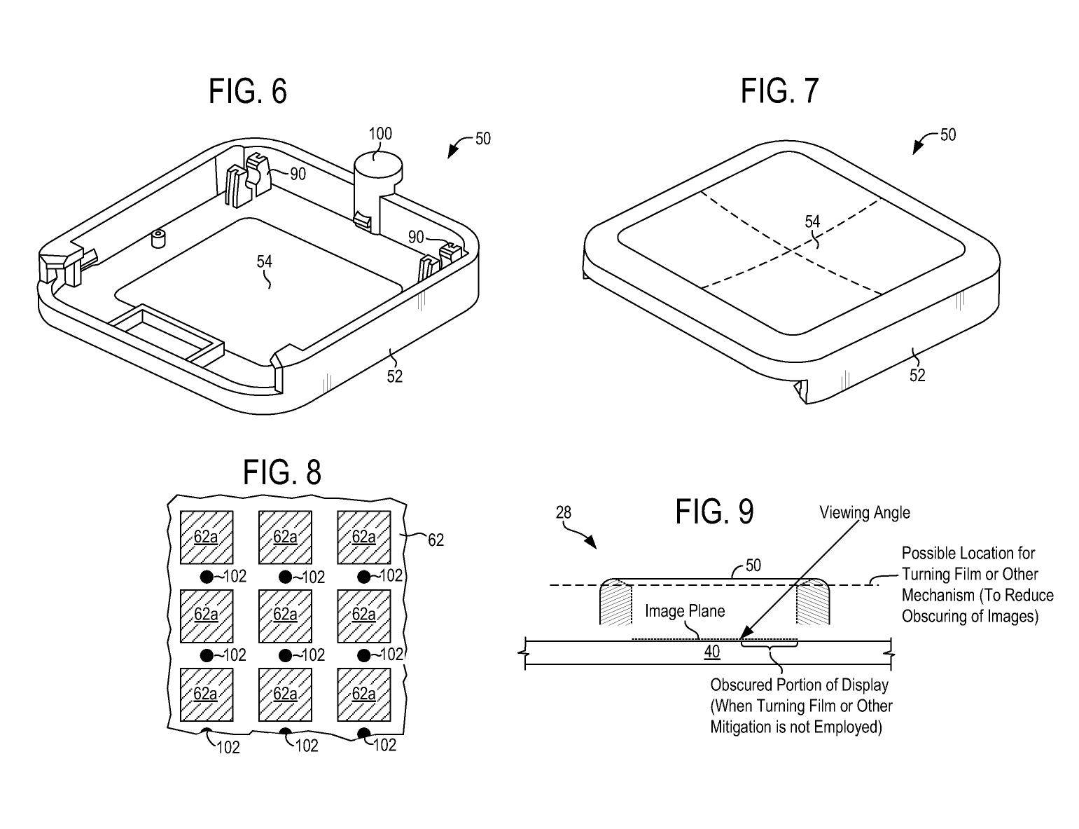

Referring now specifically to FIGS. 4 and 5, the figures show partial-section views of a portion of keyboard assembly 42, including an embodiment of an individual key 28. Key 28 includes a keycap 50 having a perimeter portion 52 and a central portion 54. In some constructions, perimeter portion 52 and central portion 54 are formed as separate distinct pieces, and will thus sometimes be referred to as perimeter piece 52 and central piece 54. Many of these same structures may be seen in FIGS. 6 and 7, which respectively provide bottom and top perspective views of keycap 50.

A scissors structure 60 (FIGS. 4 and 5) is disposed between keycap 50 and a base structure 62 (FIG. 4) of keyboard assembly 42. The scissors structure is configured to enable movement of the keycap 50 upward and downward relative to the base structure 62. In particular, scissors structure 60 is configured to maintain the keycap 50 in alignment during movement and ensure that the movement is constrained to perpendicular linear movement toward and away from the base structure, without twisting, tilting, and the like. For example, it will generally be preferable that the top of the keycap remain parallel with base structure 62 during movement of the keycap.

Scissors structure 60 may include two portions 63 and 64 that pivot relative to one another via pivot point 66. Each portion includes a pair of opposed webs with a pair of rods extending between the webs. Specifically, scissor portion 63 includes web 72. Rod 74 extends from a first end of web 72; rod 76 extends from a second end of web 72. The rods extend to an opposing similar web structure that cannot be seen in FIG. 5 due to concealment by keycap 50. The other scissor portion 64 includes similar structures: web 82, rods 84 and 86, and an opposing web structure that is concealed in FIG. 5.

Scissors structure 60 may be variously configured and formed from a variety of different materials. In some embodiments, the entire structure may be plastic. It may be desirable in other examples to form some or all of the parts from metal. In particular, some embodiments employ plastic webs that are over-molded around metal connecting rods. Such use of metal rods may be advantageous when stiffness and rigidity are of particular concern, for example in the case of large format keys (e.g., the “shift” key or “tab” key of a keyboard).

It will be appreciated that the portions of the scissors structure 60 pivot relative to one another when the key is depressed downward toward base structure 62. The pivoting action results in an overall lowering of the scissors structure, and produces a slight increase in the effective length of the scissors structure. To accommodate this length variation, the scissors structure may be coupled with adjoining structures in a way that allows for some lateral movement. Referring specifically to the example of FIG. 4, the portions of scissors structure 60 are engaged with keycap 50 and base structure 62 as follows:
Rod 74 is snapped into a pair of snap hooks 90 (shown in FIG. 6 but not in FIGS. 4 and 5) provided on the underside of keycap 50. This engagement allows rotation of the rod, as will occur during depression of the key, but maintains the lateral position of the rod relative to the keycap.
Rod 86 abuts the underside of keycap 50, but is allowed to slide somewhat laterally during depression of the key, to accommodate the effective lengthening of the scissors structure that occurs during collapse.
Rod 84 is held by a pair of snap hooks (not shown) on base structure 62, while rod 76 abuts the base structure but is permitted to slide laterally relative to the base structure. Similar to rods 74 and 86, this arrangement holds the scissors structure generally in place while allowing for the effective length variation that occurs during the pivoting operation of the scissors structure.

With reference to FIG. 5, it will be appreciated that the scissors structure may be disposed to the periphery of each key, thereby leaving the central area of the key unobstructed and maximally available for display purposes. In particular, when keycap 50 is viewed straight on from the top of the key, the webs and rods of the scissors structure are all positioned at the periphery of the key, underneath perimeter piece 52 of the keycap. Thus, when an LCD or other display device is employed under the keyboard assembly, the peripherally-configured scissors structures allow for a greater portion of the display to be viewed without obstruction through the key (i.e., through transparent central piece 54).

Continuing with FIGS. 4 through 7, other structures and mechanisms may be employed in connection with the actuation of the key. In the present example, as keycap 50 is depressed toward base structure 62 (FIG. 4), a plunger or tab-like protrusion 100 will depress a tactile structure, such as tactile feedback dome 102 (FIG. 4), which is associated with the key. As the key moves from the rest position toward its fully depressed state, the tactile feedback dome will eventually collapse and cause a palpable change in the action or feel of the key. In addition to collapsing the feedback dome, the depression of the key causes occurrence of an electrical event which produces the input signal or command associated with the key. In one example, a three-layer construction is used on base structure 62, in which conductors 110 and 112 are separated by insulating layer 114. The layers collectively form a switch mechanism. In particular, depression of the key and collapse of the tactile feedback dome causes conductors 110 and 112 to contact each other through a hole 114a in insulating layer 114, thus establishing an electrical connection which produces the input signal.

Regardless of the exact mechanism by which the signal is generated, use of a tactile structure provides tangible, haptic feedback which affirms that the user's physical movement (i.e., pressing of the key) has in fact sent the desired input signal to the attached computer. The tactile structures may be implemented as tactile feedback domes formed from metal or silicone, or other rubber-like dome structures, to name but a few possible examples. Selection of a particular type of tactile structure may be informed by tradeoffs and considerations relating to key feel, keyboard thickness, display performance, manufacturing concerns, robustness, reliability and the like. As will be described in more detail below, display performance can be enhanced in certain embodiments by having a thinner keyboard assembly. Tactile feedback domes made of metal can often be employed to reduce the keyboard assembly thickness (relative to other types of domes), however in some cases these domes are less desirable from a tactile feel standpoint. Conversely, a rubber-like tactile dome may provide the desired feel or action for the keyboard, but at the expense of an increased thickness which can affect the display performance.

FIG. 8 shows an exemplary arrangement of tactile structures on or in relation to base structure 62. Specifically, the figure shows a portion of base structure 62 corresponding to a region containing nine square-format keys, for example, from a central portion of the keyboards shown in FIGS. 1-3. For clarity of illustration, the keys themselves are not shown in the figure. The hashed regions indicate holes 62a in the base structure 62. These holes are generally aligned with the transparent central portions of the keycaps (e.g., central transparent pieces 54—shown in FIGS. 4-7), to facilitate viewing through the keyboard assembly to the underlying display device. The figure also shows that the tactile structure for each key (e.g., tactile domes 102) is offset from the central display portion of the key, so as to not interfere with the display functionality. Indeed, similar to the scissors structure configuration discussed in connection with FIGS. 4 and 5, the tactile structures are positioned at the periphery of the keys so as to maximize use of the central portion of the key for display. In addition to or instead of holes 62a, base structure 62 may be constructed from a transparent material to facilitate the display capability. Also, the base structure may include a rigid piece or expanse to retain and/or support the key structures, and a separate flexible portion containing the insulating and conducting layers that provide the above-described electrical switching and connectivity.

As an alternative to the depicted arrangement, the tactile structures may be provided in other locations that do not impede display of images through the keycaps. For example, the tactile structure may be provided at a top or side edge of the holes in the base structure, as opposed to a bottom edge. Furthermore, tactile structures may be positioned underneath the scissors assembly such that they are compressed by actuation of the scissors assembly. Regardless of the particular configuration, the centrally offset position of the tactile structures will often be desirable in that it minimizes or eliminates the possibility of interfering with the through-key display functionality.

As discussed throughout, various considerations can arise relating to the viewing of images produced by display device 40 (FIG. 2). Some of these considerations relate to the fact that in the typical arrangement, the image source (i.e., display device 40) is located under keyboard assembly 42. The user must therefore be able to look “through” the keyboard assembly to see the images. On the other hand, some portions of the keyboard assembly may not be transparent for various reasons, and it may be desirable to configure such “non-display” portions of the keyboard so that they do not detract from or otherwise impede the display functionality.

In some cases, it may be desirable to implement a display device in which the image plane is beneath the keys, at the surface of the display device. This is in contrast to a method involving projection of the image plane to a location on top of the keys, at some distance above the surface of the display device. Referring to FIG. 9, the figure shows a simplified schematic of key 28 disposed over display device 40. The keycaps and related structures have a thickness (e.g., between 2 and 10 millimeters), and therefore there is a potential for a “tunnel” effect through the center of each key, in which the user is looking through a rectangular tube to see the image associated with the key. Given an approximate viewing angle of 45 degrees, the thickness of the key results in a significant portion of the image plane being obscured, as indicated in the figure. This effect may be remediated to some extent through the use of turning films and/or prisms employed in the central portion of the key to increase the visible display area of the underlying display device.

The obscuring of the display may be mitigated to some extent through use of turning films and/or prisms employed in the central portion of the key. In particular, it will be desirable in some embodiments to employ a turning element in connection with the keycap. It will often be desirable that the turning element be employed near the top of the key, for example near the upper surface of the keycap 50. Light rays from the underlying display device would then be refracted toward the user at a point near the top of the key. Because the refraction is occurring near the top of the key, the sidewall portions of the key will obscure less of the display. FIG. 9 indicates a potential location for employing a turning film or prism. When employed, a turning film section or layer may be co-molded with the keycap, or may be joined to the keycap via adhesive, snap-fitting, ultrasonic-welding or any other suitable joining method. In addition to or instead of a turning film, the turning element may be implemented with a turning prism. As with the turning film, the turning prism may be implemented so that the point of refraction is near the top of the key.

As indicated above, the keys of the computer peripheral will typically be employed so that the central portion of each keycap is transparent, allowing the user to see images from the display device through the keycap. As previously discussed, it will often be desirable to configure supporting mechanical components (e.g., the scissors structure) so that they are located at the periphery of the key, so as to not block images being viewed through the central portion of the key. Furthermore, for aesthetic and other reasons, in some cases the peripheral portion of the keycap will be made opaque in order to conceal the scissors structure (e.g., to provide a cleaner look and/or to prevent visual distractions that might take focus away from the images being provided by the display device).

One approach to providing opacity at the periphery while permitting light/images to pass through the center is to form the keycap as a single transparent piece and then paint the periphery of the keycap. Precision painting operations can be difficult, however, and particularly so when performed in mass production settings with small parts. Also, the painting operation is a separate step that can increase the time and cost of manufacturing. Accordingly, in some cases it will be advantageous to form a two piece keycap in which the central portion and the perimeter portion are separate. The above-described examples discussed with respect to FIGS. 4 through 7 all provide examples of such a two-piece keycap construction.

Separate-piece constructions for keycap 50 may be achieved in a variety of ways. In some embodiments, central piece 54 and perimeter piece 52 are molded or otherwise formed separately, and then affixed to one another in a separate joining step. Attachment may be achieved via snap fitting, adhesive (e.g., pressure-sensitive adhesive), ultrasonic welding, or any other suitable joining method. Alternatively, the two pieces may be formed as separate distinct pieces, but in a co-molding process, in which one of the pieces is molded first, and then the second piece is molded onto or over the first.

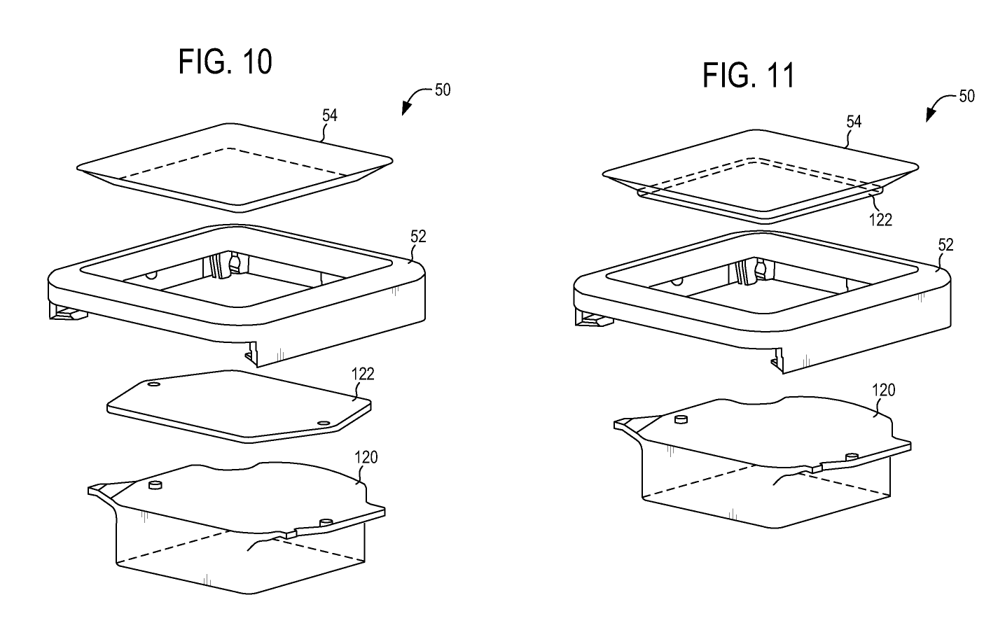

FIGS. 10 and 11 are exploded views which provide further examples of keycaps 50 employing a two-piece construction in which central piece 54 and perimeter piece 52 are separate pieces. Both examples show use of an optional light pillar 120 located in the central viewing area of the key. In some settings, use of a light pillar can reduce the tunnel effect described above by creating a perception that the image plane is raised off of the underlying display device. In addition to or instead of a light pillar, a prism may be employed to turn light from the display device toward the user, so as to increase the effective size of the viewable display (i.e., by countering the display reduction resulting from the user's viewing angle). In combination with or separately from a prism, a turning film 122 may be employed to counter the viewing angle effect. In the example of FIG. 10, the central piece 54, perimeter piece 52, turning film 122 and light pillar 120 are assembled together via snap-fitting, adhesive, sonic-welding or other appropriate joining method. Assembly and construction is similar in FIG. 11, except that the depicted embodiment shows use of a co-molded construction for central piece 54 and turning film 122.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computer peripheral, comprising:
a display device; and
a keyboard assembly disposed over the display device and configured to permit viewing of images produced by the display device through the keyboard assembly, the keyboard assembly including a plurality of keys, where each of the plurality of keys:
is selectively physically depressible to cause production of an input signal, and
includes a keycap having a perimeter piece and a central piece, the central piece being transparent so as to permit passage of light from the display device through the central piece to a user of the keyboard assembly.

2. The computer peripheral of claim 1, where for each keycap, the perimeter piece and the central piece are co-molded.

3. The computer peripheral of claim 1, where for each keycap, the perimeter piece and the central piece are formed separately and then attached together in a separate joining step.

4. The computer peripheral of claim 1, where for each of the plurality of keys, a scissors structure is disposed between the keycap and a base structure of the keyboard assembly, the scissors structure being adapted to constrain the keycap to generally perpendicular linear movement toward and away from the base structure of the keyboard assembly.

5. The computer peripheral of claim 4, where for each of the plurality of keys, the perimeter piece of the keycap is opaque and the scissors structure is disposed to a periphery of the key so that the perimeter piece substantially obscures the scissors structure and so that the scissors structure does not block viewing of images from the display device through the central piece of the keycap.

6. The computer peripheral of claim 5, where for each of the plurality of keys, a tactile structure is provided on the base structure to provide tactile user feedback when the key is depressed from a rest position toward the base structure, and where the tactile structure for each of the plurality of keys is centrally offset relative to the key.

7. The computer peripheral of claim 6, where the tactile structure for each of the plurality of keys is a tactile feedback dome formed from metal.

8. The computer peripheral of claim 6, where the tactile structure for each of the plurality of keys is a tactile feedback dome formed from a rubber-like material.

9. The computer peripheral of claim 1, where the keyboard assembly includes a base structure to which the plurality of keys are movably coupled, the keyboard assembly further including a plurality of tactile structures on the base structure to provide tactile user feedback when any of the plurality of keys is depressed from a rest position toward the base structure.

10. The computer peripheral of claim 9, where for each of the plurality of keys, a scissors structure is disposed between the keycap and the base structure of the keyboard assembly, the scissors structure being adapted to constrain the keycap to generally perpendicular linear movement toward and away from the base structure of the keyboard assembly.

11. The computer peripheral of claim 9, where each of the plurality of tactile structures is a tactile feedback dome formed from metal.

12. The computer peripheral of claim 9, where each of the plurality of tactile structures is a tactile feedback dome formed from a rubber-like material.

13. The computer peripheral of claim 9, where the plurality of tactile structures are each centrally offset relative to the plurality of keys.

14. The computer peripheral of claim 1, further comprising, for each of the plurality of keys, a turning film layer disposed in a central portion of the key so that display light from the display device passes through the turning film layer.

15. The computer peripheral of claim 1, further comprising, for each of the plurality of keys, a prism disposed in a central portion of the key so that display light from the display device passes through the prism.

16. A method of manufacturing a computer peripheral, comprising:
providing a display device;
assembling a keyboard assembly from a base structure, a plurality of keycaps, and a plurality of scissors structures operatively coupled between the base structure and the plurality of keycaps to enable the plurality of keycaps to move toward and away from the base structure; and
disposing the keyboard assembly over the display device so that images produced by the display device are viewable through the keyboard assembly, where each of the plurality of keycaps is formed from a perimeter piece and a central piece which is transparent to permit passage of light from the display device to a user of the keyboard assembly.

17. The method of claim 16, where forming each of the plurality of keycaps includes forming the perimeter piece and the central piece separately, and then attaching them together in a separate joining step.

18. The method of claim 16, where forming each of the plurality of keycaps includes co-molding the perimeter piece and the central piece.

19. The method of claim 16, further comprising disposing each of the scissors structures toward a periphery of its associated key, so that the scissors structure does not block passage of light from the display device through a central portion of its associated key.

20. A keyboard with a liquid crystal display (LCD)-enabled, through-key display capability, comprising:
an LCD display device; and
a keyboard assembly disposed over the LCD display device and configured to permit viewing of images produced by the LCD display device through the keyboard assembly, the keyboard assembly including a plurality of keys, where each of the plurality of keys:
is selectively physically depressible to cause production of an input signal;
includes a keycap having a perimeter piece and a central piece, the central piece being transparent so as to permit passage of light from the display device through the central piece to a user of the keyboard assembly; and
includes a scissors structure disposed between the keycap and a base structure of the keyboard assembly, the scissors structure being adapted to constrain the keycap to generally perpendicular linear movement toward and away from the base structure of the keyboard assembly, the scissors structure being disposed toward a periphery of the key so that the scissors structure does not block viewing of images from the display device through the central piece of the keycap.
